(19) United States
(12) Patent Application Publication
(10) Pub. No.: US 2002/0067037 A1
(43) Pub. Date: Jun. 6, 2002

(54) Souvenir travel guidebook and photo album system

(76) Inventor: Arthur Lo, Kaneohe, HI (US)

Correspondence Address: Arthur Lo, 47-220 Hui Aeko Way, Kaneohe, HI, 96744, US

(21) Appl. No.: 09/970,123

(22) Filed: Oct. 4, 2001

Related U.S. Application Data
(60) Provisional application No. 60/235,348, filed on Sep. 26, 2000.

(51) Int. Cl. B42D 1/00

(52) U.S. Cl. 281/15.1

(57) ABSTRACT

The invention provides a souvenir travel guidebook with an ability to have holding members on the same page of a printed material to be utilized for displaying traditional photographs, for storing mounted or unmounted slide transparencies of varying sizes, picture/photo CD's, floppy disks, postcards, tickets and other travel memorabilia. It is a new method to display and organize the above items in such a way that the souvenir travel guidebook itself is also the photo album.

### BACKGROUND OF THE INVENTION

1. Field of Invention

This invention relates in general to a souvenir travel text and picture guidebook with a photo album system, wherein the same travel guidebook has the ability to display personal photographs of various sizes, as well as store items such as slide transparencies of various sizes, picture/photo CD's, floppy disks, postcards, tickets and other memorabilia in relation to a certain subject, location or site visited in one's travels or tours. Many people take personal photographs during trips and file them in a photo album to show to friends and families. Many want to remember the names of places, facts and other information pertinent to photographs they have taken of the sites they have been to, but often forget without the use of a travel guide book.

2. Description of Prior Art

Prior to this invention, people normally buy postcards or write personal notes on stick-on labels and display them together with their photographs in a photo album in order to remember the different sites they have visited. An example of one photo album includes that of a loose-leaf volume of U.S. Pat. No. 5,213,370 awarded to Hood on May 25, 1993. It describes an expandable album or binder for storing photographs, with the front and back cover of the album hinged to a spine which has page retaining channels that allow loose leaf pages to be inserted into or removed from the album. The disadvantage of this method is that the loose form of the postcards may make them prone to loss or misplacement due to improper handling.

U.S. Pat. No. 4,965,948 awarded to Ruebens in Oct. 30, 1990 consist of a Bi-directional album with a memo area. This allows the display of either longitudinal or latitudinal vertically oriented photographs on the same area of an album display page, covered by a transparent cover attached to each display page of each album leaf. A memo area is provided on each display page for recording information about the adjacently stored photographs. The disadvantage of this is that the information that can be noted about the adjacent photograph may be limited, especially if it is about a historical landmark or scenic location of a tourist attraction and may not include the more important facts that are usually enclosed in a travel guidebook. This setup of having a memo area beside an adjacent photograph may also not be as stimulating and attractive a layout as desired.

### BRIEF SUMMARY OF THE INVENTION

The present invention overcomes these problems by providing a souvenir travel guidebook and photo album system in one. It is done by combining a souvenir travel guide containing informative text and colorful pictorial representations of different subjects, sites and locations with picture holding members embedded on the same pages as the printed material or on separate sheets in a bounded form. It can also be in the form of a ring binder book, which have page-retaining channels that allow loose photo album sheet refills to be inserted into or removed from the book to store additional photographs taken by the person in relation to the sights visited.

This invention relates to a system for storing and displaying personal photographs in various sizes for viewing, providing not only an enhanced display of these photographs in the book but also printed material sheets that can be viewed directly or through transparent or semi-transparent slip-in rectangular photograph pockets in web form. The informative text and colorful pictorial representations of the printed material sheets are meant to be used in conjunction with the personal photographs that are mounted over them or inserted in the photograph pockets superimposing over these printed materials. This combination souvenir travel guide with photo album system portray tourism sites, historical landmarks and scenic locations to build a personalized travel guide and photo album system, providing readers with a good general overview of a variety of areas and sites.

Besides displaying personal photographs of various sizes, it also has plastic pouch like members contained in the photograph pockets which can store slide transparencies of various sizes, picture/photo CD's, floppy disks, postcards, tickets and other items that one may choose to keep as travel memorabilia. This souvenir travel guidebook with photo album system is capable of displaying multiple personal photographs in an attractive manner, relating to a particular site or subject displayed in the printed material sheet. The easy-to-use format puts it all at the user's fingertips. The present invention is directed towards a new type of photographic display combined with a personalized destination guide that's adapted for use by anyone.

The mounting materials for the personal photographs are in predetermined arrangement corresponding to the printed material sheet. The users may mount or display their photographs over the printed material sheets that match their subject. This souvenir travel guide book with photo album system is a good travel reference and is also used as a photo album system with the most delightful background printed materials in full color or black and white images in a single book. The practical information gives users or readers the tools to explore and check out a lot of specific information about each location. This combination is what makes the souvenir travel guidebook with photo album system unique. The surface of the printed material sheet carries the information and data uniquely associated with the subject of the personal photographs that have the same scenic images as the pictorial representations of the printed material sheets they are mounted on. Each of these images is associated with a page full of related personal photographs. In addition, the general information will provide sufficient information for users or readers, who will also enjoy many colorful pictorial representations of many famous tourist attractions. Furthermore, the users or readers will continue to flip from page to page to have a self-navigated discovery of the entire book. Organized for ease of use, the mounting materials for the personal photographs can be left as is without mounting any personal photographs to be able to view the underlying pictorial representations of the printed material sheets.

This book is unsurpassed in quality and light enough to carry around. An ideal souvenir for anyone to keep, it is designed for the public and especially for tourists. This present invention will have a front cover and back cover made of heavy cardboard that can also have soft padding and then covered with fabric, plastic or leather. The front cover will have a window opening that will allow viewing of the second page with a mounted photograph or a transparent pocket made of plastic material will be mounted on the cover page to allow the owner of the book to display one of their favorite photographs from the trip, making it a personalized souvenir travel guide with combination photo album system.

### DETAILED DESCRIPTION OF THE INVENTION

FIG. 1 represents the combination travel guidebook and photo album in bounded form wherein 1 depicts a page pair consisting of non transparent leaf pages with pictorial representations 1A and 1B text descriptions or information about the subject or site, 3 is the transparent plastic cover of a predetermined size wherein the top edge 4, one side edge 5 and the bottom edge 6 are attached to the non transparent leaf page, the opposite side edge 7 is not attached forming a pocket capable of inserting 2, personal photographs of various sizes.

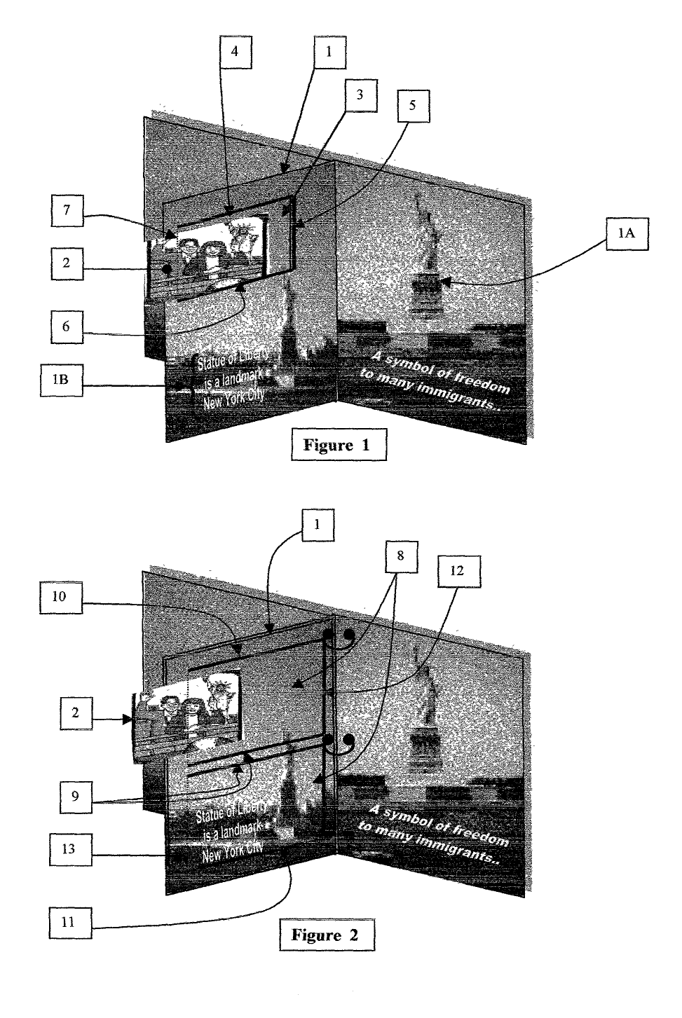

FIG. 2 represents the combination travel guidebook and photo album in ring binder form, wherein 8 is one whole plastic transparent sheet attached to 1 the non transparent leaf page separated by attachment lines 9 running parallel to the top edge 10 and bottom edge 11, in which the top edge 10, the bottom edge 11 and one side edge 12 are attached to the non transparent leaf page 1 with the opposite side edge 13 un-attached forming several pockets capable of accepting photographs of various sizes.

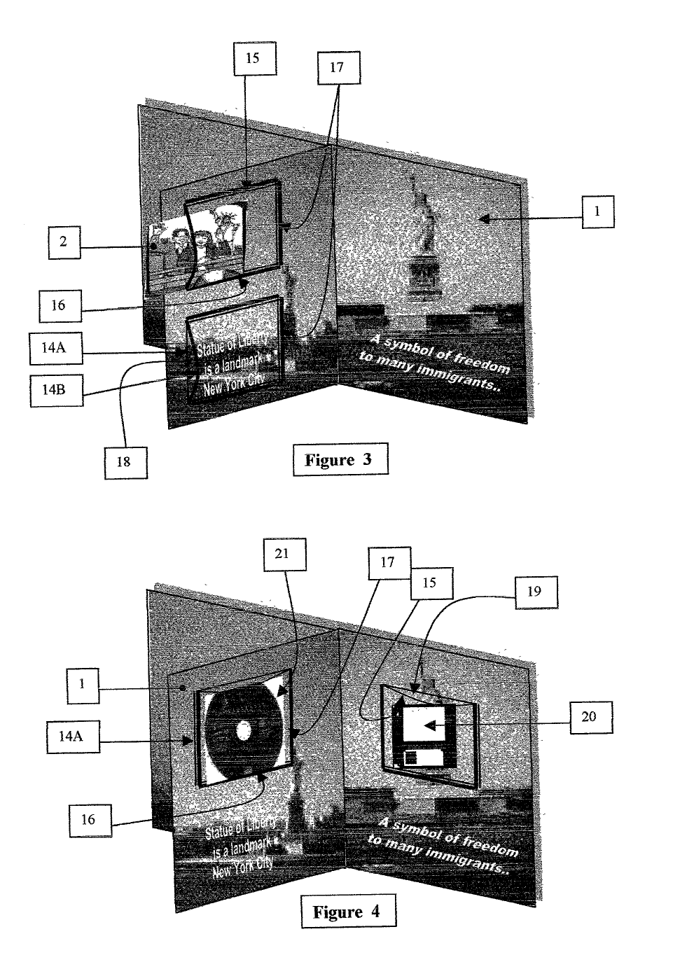

FIG. 3 is another method of mounting photographs where in two transparent plastic sheets of a predetermined size, comprising of an inner sheet 14A and an outer sheet 14B which are heat sealed together along the top edge 15, a bottom edge 16 and one side edge 17 with the opposite side edge 18 un sealed to form a pocket capable of inserting personal photographs 2.

FIG. 4 refers to the same pocket as in FIG. 3, in which this same pocket through its inner transparent plastic sheet 14A is attached to a non transparent leaf page 1 along a bottom edge 16 and side edge 17 and inner sheet 14A, with the top edge 15 un-attached forming a pouch through its opening 19 forming a pouch capable of storing floppy diskettes 20 and compact disks 21 and other related travel memorabilia such as slides transparencies, tickets and the like.

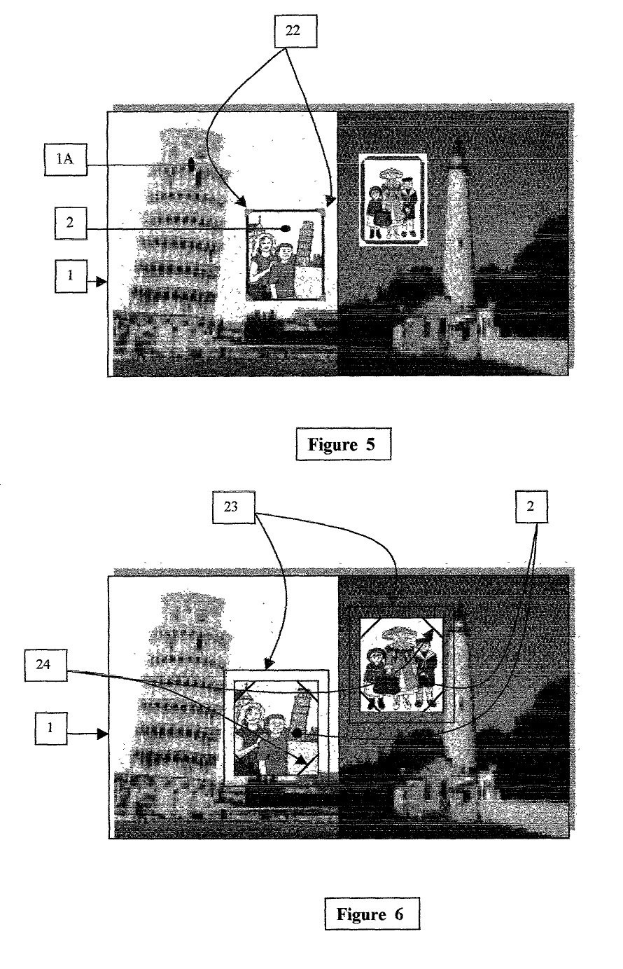

FIG. 5 represents another method of mounting personal photographs over the underlying pictorial representation 1A by using commercially available corner mounts 22 adhesively attached to the non-transparent leaf page 1, through which personal photographs 2 can be mounted.

FIG. 6 represents another method of mounting personal photographs by using a member fabricated of heavy duty transparent plastic 23 attached to a non transparent leaf page 1 wherein this heavy duty transparent plastic 23 has four pre-formed comer slots 24 angled at 45 degrees in which personal photographs 2 can be mounted.

1. What I claim as my invention is combining a souvenir travel guidebook with a photo album system capable of displaying multiple personal photographs and other travel memorabilia, using different mounting methods, already available in the market, wherein these mounting methods are applied directly on certain predetermined pages of the travel guidebook.

2. The souvenir travel guidebook and photo album system in claim 1, containing predetermined arrangement of pages which have backgrounds of printed material with pictorial representations that cover predetermined page pairs comprising two sides, in which one or both sides of each page pair contains vital facts and descriptions of the selected sites or subjects, whereas one or both sides of the page pair can be utilized as visible underlying pictorial representations, on which different methods are used to mount personal photographs of various sizes, taken in relation to that specific site or subject; these personal photographs can then serve as overlying superimposed pictorial representations.

3. The souvenir travel guidebook and photo album system in claim 2, wherein one method of mounting the personal photographs is that one or both sides of the page pair has 2 or more transparent plastic covers of a predetermined size which are individually attached to a page pair's non-transparent leaf page containing background printed material, wherein each transparent cover is attached to the non-transparent leaf page along a top edge, a bottom edge and one side edge while the opposite side edge is unattached with an opening forming a pocket capable of slipping in or inserting personal photographs of a predetermined size, as well as various other smaller sizes.

4. The souvenir travel guidebook and photo album system in claim 2, wherein another method of mounting is that two transparent plastic sheets of a predetermined size are fastened to each other by heat sealing forming a transparent pocket with a sealed top edge, a sealed bottom edge and a sealed first side edge, with the opposite side edge un-sealed to form an opening capable of slipping in or inserting personal photographs of a predetermined size as well as various other smaller sizes; the same transparent pocket is mounted over an underlying pictorial representation on the non-transparent leaf page and through an adhesive layer on its inner transparent plastic sheet, it is attached to the non-transparent leaf page along a bottom edge, a first side edge and an opposite side edge, with the top edge unattached to form a pouch having an opening capable of storing other forms of storage media such as compact discs, floppy diskettes, slide transparencies, tickets and other memorabilia relating to the sites or subjects presented; the same transparent pocket with adhesive base may also be provided separately in loose form, for them to be positioned by the user and adhered in any orientation on top of the underlying pictorial representation.

5. The souvenir travel guidebook and photo album system in claim 2, wherein another method of mounting personal photographs is that over the visible underlying pictorial representation, comer mounts are adhered sectionally in four comers in a predetermined manner for photographic size, to provide as an embracement of the proximate comers of the overlying personal photographs, securely retaining them on top of the underlying pictorial representation, without necessitating the use of any other adhesive or fastener and that these comer mounts with adhesive base may also be provided separately in loose form, for them to be positioned by the user and adhered in any orientation on top of the underlying pictorial representation, to embrace any chosen size of overlying personal photographs.

6. The souvenir travel guidebook and photo album system in claim 2, wherein another method of mounting personal photographs is that a member fabricated of heavy-duty transparent plastic, cut in a rectangular form of a pre-determined size, is mounted through its inner surface by a plurality of spaced apart areas of adhesive and oriented in a predetermined manner either longitudinally or latitudinally, as a superimposing transparent plastic cover over the visible underlying pictorial representation; this transparent plastic cover is imperforate with the exception of four pre-formed corner slots, cut with a trapezoidal shape at a 45 degree angle and provided with round edges to hold comers of personal photographs in place in which the photographs serve as detachable overlying pictorial representations as cited in claim 2; the adhesives on the inner surface of the superimposing transparent plastic cover are spaced away from the comer slots.

7. The souvenir travel guidebook and photo album system in claim 2, wherein another method of mounting the personal photographs is that one side of each page pair has one transparent plastic cover of the same size sheet as one side of each page pair, individually attached to a nontransparent leaf page containing background printed material, wherein each transparent plastic cover is attached to the non-transparent leaf page along a top edge, a bottom edge and a first side edge of the same transparent cover and further attached along one or more attachment lines extending from the same first side edge to an opposite unattached second side edge, with the attachment lines running parallel to said top and bottom edges, whereby photographs of various sizes can be inserted between the free end of an attachment line and the said unattached second side edge.

8. The souvenir travel guidebook and photo album system in claim 2 may be in bounded form with front and back cover made of heavy cardboard which can also have soft padding and covered with either fabric, plastic or leather material. It may also be in the form of a binder wherein the front and back cover are hinged to a spine that have page retaining channels allowing additional loose-leaf pages or album refills to be inserted into the book for displaying additional photographs relating to the sites visited.
